(19) United States
(12) Patent Application Publication
(10) Pub. No.: US 2007/0151035 A1
(43) Pub. Date: Jul. 5, 2007

(54) Detachable auxiliary handle for power tool

(76) Inventor: Yasheng Chen, Nanjing (CN)

Correspondence Address: MCDERMOTT, WILL & EMERY LLP, 227 WEST MONROE STREET, CHICAGO, IL, 60606-5096, US

(21) Appl. No.: 11/639,970

(22) Filed: Dec. 14, 2006

(30) Foreign Application Priority Data
Dec. 15, 2005 (CN) 200520139817.3

(51) Int. Cl. B25F 1/00; B23D 49/00

(52) U.S. Cl. 7/148; 16/426; 30/392

(57) ABSTRACT

The present invention discloses a detachable auxiliary handle for a power tool, comprising a grasping portion and a connecting end which is attachable to a corresponding connecting means of a body of the power tool. The detachable auxiliary handle further includes a screw driver head. The auxiliary handle may be fixed to the body via the connection between the connecting end and the connecting means of the body of the power tool. When an operator needs to tighten or loose a bolt, he or she may detach the auxiliary handle from the body of the power tool, and use the auxiliary handle as an screw driver, thereby without needing to carry an additional screw driver, and bringing convenience for the operator.

### CROSS-REFERENCE TO RELATED APPLICATIONS

This application claims priority to Chinese Application No. 200520139817.3 filed Dec. 15, 2005, the entire disclosure of which is incorporated herein by reference. Priority to this application is claimed under 35 U.S.C. 119, 120 and/or 365.

### FEDERALLY SPONSORED RESEARCH OR DEVELOPMENT

Not Applicable.

### TECHNICAL FIELD

The present invention relates to a detachable auxiliary handle, which may be used for power tools, such as electrical drill, electric hammer, electric polisher, jig saw, etc.

### BACKGROUND OF THE INVENTION

During operating a power tool, to tight or to loose a bolt is often occurred. As an example, a base plate of a jig saw generally comprises a upwardly arched portion which has an elongated hole in the top portion thereof, and the fitting face of the body of the jig saw has a corresponding arched concave. A bolt connects to a fixing block or a nut fixed in the body by passing through the through hole of the arched portion of the base plate and, thereby obtaining a fixing connection between the base plate and the body. When needing to adjust inclination or front-and-back position of the base plate, the bolt needs to be loosed firstly, and then the base plate is adjusted to a desired position before finally tightening the bolt. So in the prior art, an additional screw driver is often needed to tighten or loose the bolt, which bringing certain inconvenience for users.

### SUMMARY OF THE INVENTION

An object of the present invention is to overcome the above-mentioned inconvenience, and to provide a screw driver associated with the power tool itself.

To obtain the above-mentioned object, a detachable auxiliary handle for a power tool provided by the present invention comprising a grasping portion and a connecting end, wherein the connecting end is attachable to a corresponding connecting means of a body of the power tool, and the auxiliary handle further comprises a screw driver head.

Thus, the auxiliary handle may be fixed to the body via a connection between the connecting end and the corresponding connecting means of the body of the power tool. During normal operation, the operator may operate with one hand grasping the main handle and with the other hand grasping the auxiliary handle, which facilitates the balance of control force of the operator. When the operator needs to tighten or loose the bolt, he or she may detach the auxiliary handle from the body of the power tool, and uses the auxiliary handle as a screw driver, thereby without needing to carry an additional screw driver, and bringing much convenience for the operator to use.

As a further improvement, the screw driver head of the auxiliary handle is detachable, for fitting with different types of bolts.

### BRIEF DESCRIPTION OF THE DRAWINGS

The detailed description of the present invention will be further illustrated accompany with drawings, wherein

FIG. 1 is a perspective view of an auxiliary handle having a screw driver head according to a preferred embodiment of the present invention;

FIG. 2 is a front view of the auxiliary handle having a screw driver head of FIG. 1 being mounted onto a jig saw;

FIG. 3 is a top view of the jig saw; and

FIG. 4 is a side view of the jig saw of FIG. 2 during inclined cutting.

### DETAILED DESCRIPTION

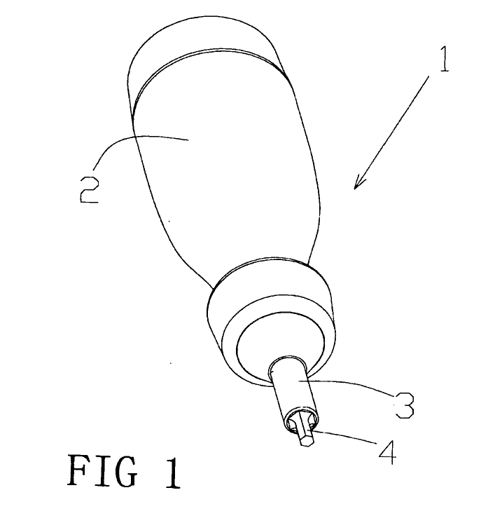

Referring to FIG. 1, an auxiliary handle 1 includes a grasping portion 2, a connecting end 3, and a screw driver head 4. In this preferred embodiment of the present invention, the screw driver head 4 is hexagon-shaped. However, the screw driver head 4 of the present invention is not limited to the shape as shown in the drawings, and the screw driver head 4 is preferred to be detachable to adapt for various types of screws.

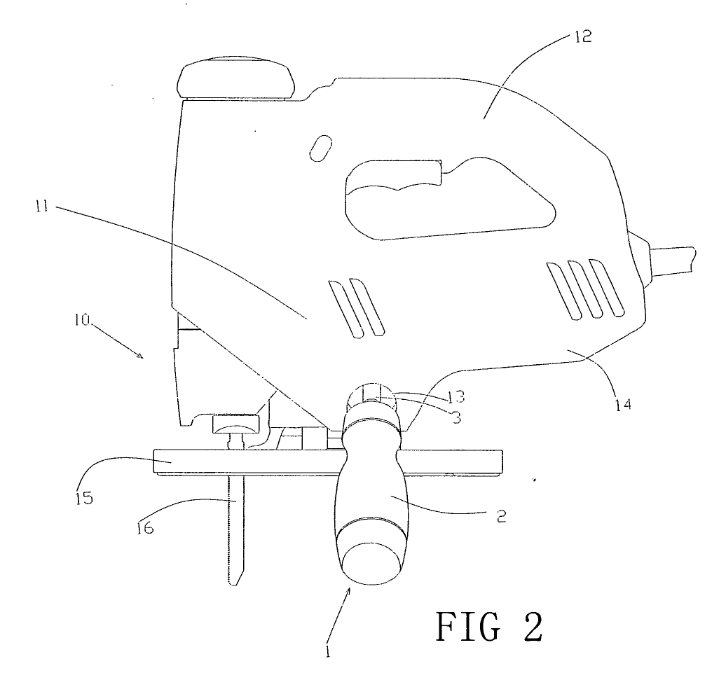

A jig saw 10 as shown in FIG. 2 comprises a body 11, a saw blade 16, and a base plate 15, wherein the body 11 comprises a driving system (not shown) contained therein, for driving the saw blade 16 to perform a reciprocating movement, thereby to cut a workpiece positioned below the base plate 15. The jig saw 10 further comprises a main handle 12, and the body 11 includes a connecting means 13 corresponding to the connecting end 3 of the auxiliary handle 1. In this embodiment, the connecting end 3 is a threaded pin, while the connecting means 13 is a threaded hole engageable with said threaded pin. Obviously, such a thread engagement is only one preferred embodiment, and the connecting end 3 and the connecting means 13 are also not limited to such described structures, any other structures that are obvious to a person skilled in the art are available.

Thus, the auxiliary handle 1 may be fixed to the body 11 via the connection between the connecting end 3 and the connecting means 13. During normal operation, the operator may operate with one hand grasping the main handle 12 and with the other hand grasping the auxiliary handle 1, which facilitates the balance of control force of the operator.

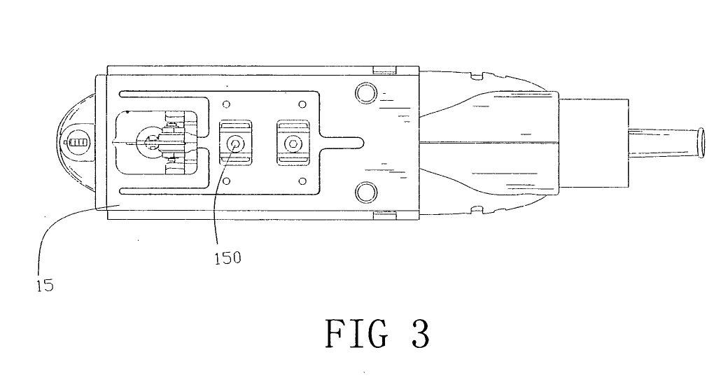

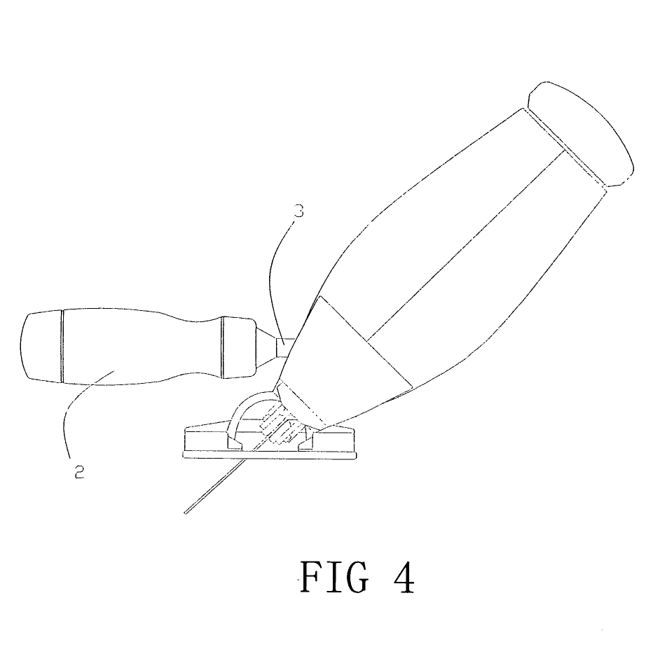

Referring to FIG. 3, a bolt 150 engages with a fixing block or the nut (not shown) fixed in the body by passing through a through hole of the base plate 15, thereby obtaining a fixing connection between the base plate 15 and the body 11. During using of the jig saw 10, the workpiece often needs to be inclined cut, as shown in FIG. 4. Thus, the inclination or the front-and-back position of the base plate 15 needs to be adjusted. Such adjustment can be obtained by demounting the auxiliary handle 1, and loosing the bolt 150 via the screw driver head 4, then adjusting the base plate 15 to a desired position before tightening the bolt 150 finally. The auxiliary handle 1 may be fixed on the body 11 again via connecting the connecting end 3 to the corresponding connecting means 13.

The auxiliary handle as disclosed in the above-mentioned description and the drawings are only the preferred embodiment of the present invention, and the power tool of the present invention does not limited to the above-mentioned jig saw, and may be other power tools which need to use the auxiliary handle, such as drill, hammer, angle grinder, etc.. It will be appreciated by one having ordinary skill in the art, through reading the above-mentioned description and drawings, that various changes in the elements and their configuration and arrangement are possible without departing from the spirit and scope of the present invention. The scope of the present invention is defined only by the claims below.

What is claimed is:

1. A detachable auxiliary handle for a power tool, comprising
a grasping portion, and
a connecting end which being attachable to a corresponding connecting means on a body of the power tool,
a tool bit mounted therewith for manually operation when the handle being detached from the body.

2. The detachable auxiliary handle for a power tool as claimed in claim 1, wherein the tool bit is detachable, and various bits can be fitted with the handle for different purpose.

3. The detachable auxiliary handle of claim 1, wherein the tool bit is a screw driver.

4. The detachable auxiliary handle of claim 3, wherein the screw driver bit is detachably mounted to the connecting end, and various types of screw driver bit can be fitted with the handle for different types of screw or bolts.

5. The detachable auxiliary handle of claim 1, wherein the power tool is a jig saw, which further comprising
a main handle fixed to the body;
a driving system for driving a saw blade to perform a reciprocating movement;
a base plate; and
a bolt passing through a through hole of the base plate and engaged with a fixing block fixed in the body for fixing the body with the base plate.

6. The detachable auxiliary handle of claim 5, wherein the tool bit being able to loose or tighten the bolt for adjusting the position of the base plate with respect to the body.
